(19) United States
(12) Patent Application Publication
(10) Pub. No.: US 2022/0309409 A1
(43) Pub. Date: Sep. 29, 2022

(54) Dynamically Adjustable Real-Time Forecasting

(71) Applicant: ServiceNow, Inc., Santa Clara, CA (US)

(72) Inventors: Rajesh Swaminathan, Santa Clara, CA (US); Pavani Baradi, British Columbia (CA); Saitej Erupaka, Santa Clara, CA (US); Andrew Krier, San Diego, CA (US); Niki Patel, San Diego, CA (US); Casey Bombacie, San Diego, CA (US)

(21) Appl. No.: 17/211,539

(22) Filed: Mar. 24, 2021

(51) Int. Cl. G06Q 10/04; G06F 3/14; G06Q 10/06

(52) U.S. Cl. CPC G06Q 10/04; G06F 3/14; G06Q 10/06315

(57) ABSTRACT

One or more processors are configured to: display prompts that allow input of: a date range specifying a portion of collected data, a cycle length, a duration, and an algorithm; generate, in real time, a forecast by executing the algorithm on the portion of the collected data and in accordance with the cycle length to produce prediction data for a period defined by the duration; display a chart representing the prediction data and prompts that allow further input of: a further date range within the period, an adjustment type, and an adjustment value; generate, in real time, an adjusted forecast in accordance with the prediction data within the further date range, the adjustment type, and the adjustment value to produce adjusted prediction data; and display an adjusted chart representing the prediction data and the adjusted prediction data.

### BACKGROUND

Forecasting is used by various entities, such as an enterprise, to determine the extent of resources expected to be needed at a future point in time. The resources could be computing resources (e.g., processing, storage, networking capacity, server capacity, and so on), human resources (e.g., the number of individuals with a particular skill set), or consumable resources (e.g., an amount of raw materials needed for an industrial process). These forecasts are typically based on historical resource utilization or demand, and can vary in complexity.

### SUMMARY

Despite using sophisticated models, forecasting is not always as accurate as desired. Notably, current forecasting capabilities are static, in that they do not allow the user to adjust the parameters of the forecast and see the results of these adjustments in real time. Given the limitations of forecasting, this dynamic adjustment can be important in order to compensate when models are unable to produce forecasts of the desired accuracy.

The embodiments herein provide the user with an ability to shift or scale resource demand up or down by a particular amount for at least part of the forecasted period, and obtain an updated forecast in real time. Thus, for example, if a model consistently forecasts resource demand to be 10% lower than it actually is, the user can scale up the resource demand accordingly. This scaling can also be applied just for a specific part of the forecasted period, such as two or three days during or after an anomalous event is expected to occur. The updated forecast can be stored for future reference and/or displayed graphically.

Further, the updated forecast also can be applied to a resource allocation schedule to indicate which parts of the forecasted period are expected to have insufficient, sufficient, or excess resources. In this manner, the user can rapidly compare various forecasts to one another and determine, in real time, the impact on resource utilization.

Accordingly, a first example embodiment may involve persistent storage containing: (i) collected data representing operational measurements related to a computational instance, and (ii) definitions of a plurality of algorithms, wherein the collected data was gathered by the computational instance over a collection period. The first example embodiment may also involve one or more processors configured to: display, on a graphical user interface, a set of prompts that allow input of: a date range that specifies a portion of the collected data, a cycle length related to values of the collected data, a duration, and a particular algorithm from the plurality of algorithms; possibly in response to receiving the input by way of the set of prompts, generate, in real time, a forecast by executing the particular algorithm on the portion of the collected data and in accordance with the cycle length to produce prediction data for a period defined by the duration, wherein the prediction data estimates values of the operational measurements during the period; display, on the graphical user interface, a chart representing the prediction data and a further set of prompts that allow further input of: a further date range within the period, an adjustment type, and an adjustment value; possibly in response to receiving the further input by way of the further set of prompts, generate, in real time, an adjusted forecast in accordance with the prediction data within the further date range, the adjustment type, and the adjustment value to produce adjusted prediction data, wherein the adjusted prediction data estimates adjusted values of the operational measurements during the further date range; and display, on the graphical user interface, an adjusted chart representing the prediction data and the adjusted prediction data, wherein the adjusted chart emphasizes the adjusted prediction data over the prediction data.

A second example embodiment may involve displaying, on a graphical user interface, a set of prompts that allow input of: a date range that specifies a portion of collected data representing operational measurements related to a computational instance, a cycle length related to values of the collected data, a duration, and a particular algorithm from a plurality of algorithms, wherein persistent storage contains: (i) the collected data, and (ii) definitions of the plurality of algorithms, and wherein the collected data was gathered by the computational instance over a collection period. The second example embodiment may also involve, possibly in response to receiving the input by way of the set of prompts, generating, in real time, a forecast by executing the particular algorithm on the portion of the collected data and in accordance with the cycle length to produce prediction data for a period defined by the duration, wherein the prediction data estimates values of the operational measurements during the period. The second example embodiment may also involve displaying, on the graphical user interface, a chart representing the prediction data and a further set of prompts that allow further input of: a further date range within the period, an adjustment type, and an adjustment value. The second example embodiment may also involve, possibly in response to receiving the further input by way of the further set of prompts, generating, in real time, an adjusted forecast in accordance with the prediction data within the further date range, the adjustment type, and the adjustment value to produce adjusted prediction data, wherein the adjusted prediction data estimates adjusted values of the operational measurements during the further date range. The second example embodiment may also involve displaying, on the graphical user interface, an adjusted chart representing the prediction data and the adjusted prediction data, wherein the adjusted chart emphasizes the adjusted prediction data over the prediction data.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A is a bar chart of collected data, in accordance with example embodiments.

FIG. 6B is a bar chart of forecasted data, in accordance with example embodiments.

FIG. 6C is a timeline based on the forecasted data, in accordance with example embodiments.

FIG. 7A is a bar chart of collected data, in accordance with example embodiments.

FIG. 7B is a bar chart of forecasted data, in accordance with example embodiments.

FIG. 7C is a timeline based on the forecasted data, in accordance with example embodiments.

FIGS. 8A and 8B depict forecast parameters, in accordance with example embodiments.

FIG. 9A is a bar chart of adjusted forecasted data, in accordance with example embodiments.

FIG. 9B is a timeline based on the adjusted forecasted data, in accordance with example embodiments.

FIG. 10 is a flow chart of forecast state, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

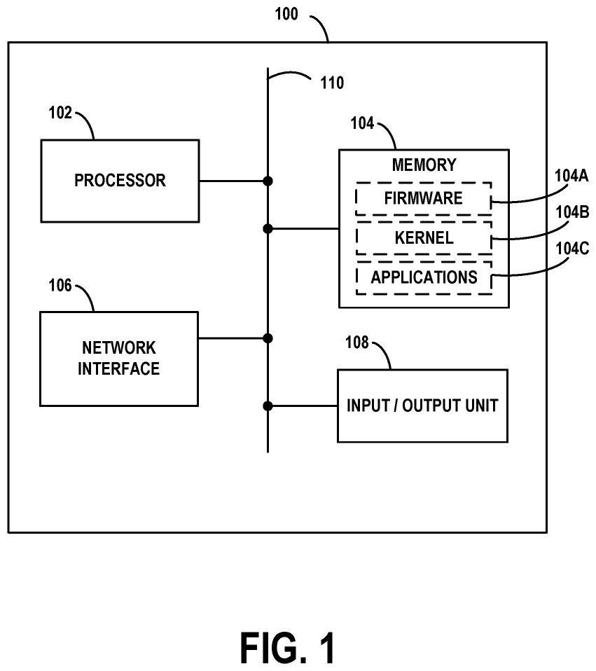

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling, and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

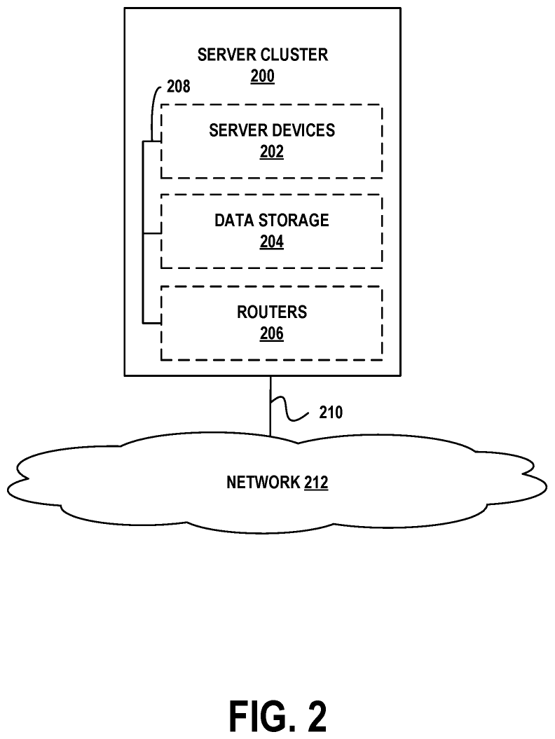

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

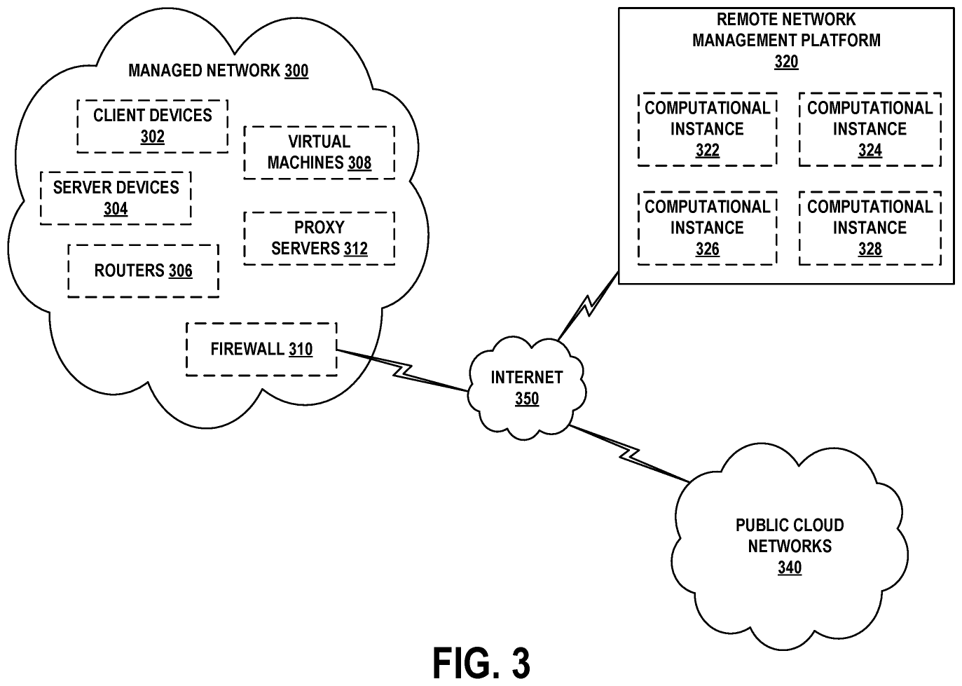

FIG. 3 depicts a remote network management architecture, in accordance with example embodiments. This architecture includes three main components — managed network 300, remote network management platform 320, and public cloud networks 340 — all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

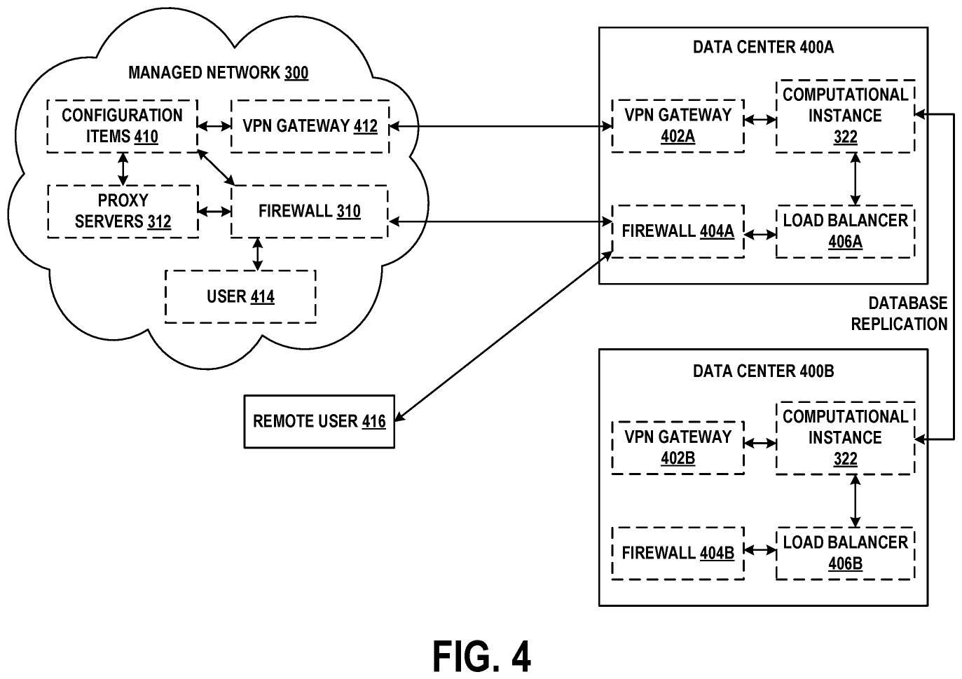

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

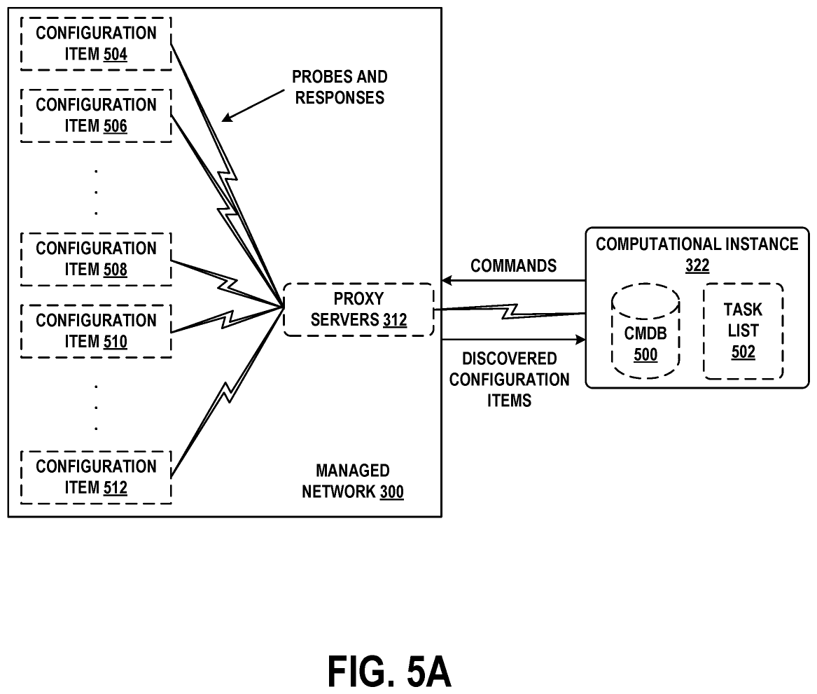

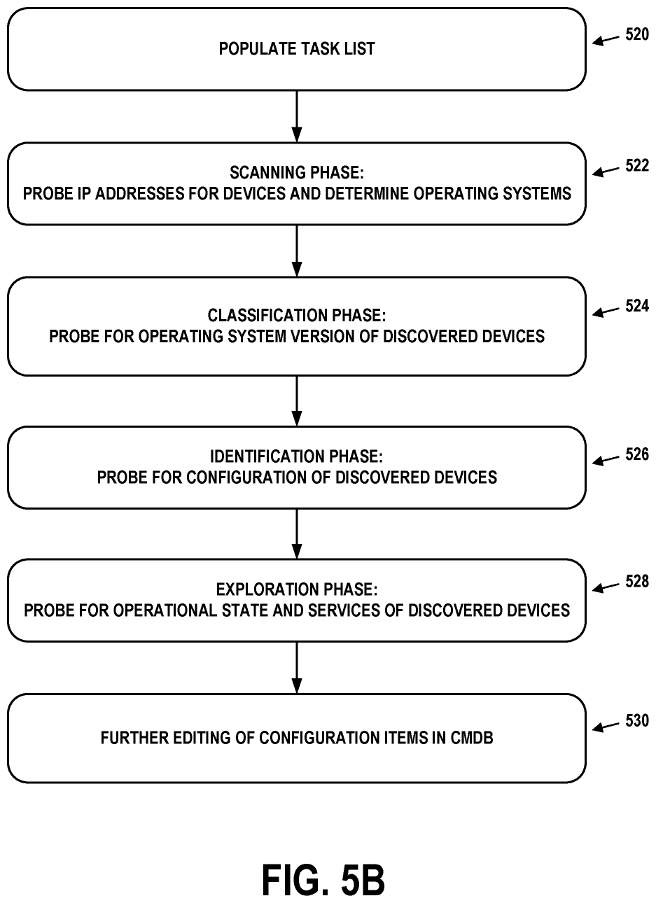

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. Dynamic Forecasting

As can be observed from the above, a remote network management platform is a complex entity supporting many different applications, features, and functions. A set of these applications, features, and functions may involve the management and allocation of resources, computer or otherwise.

For example, a computational instance may gather usage information from server devices operating on a managed network. This usage information could take the form of processor, memory (volatile storage), disk (non-volatile storage), and/or network utilization. When any of these usages approach or reach their respective limits, performance of the associated server devices can be negatively impacted. For example, a server device with high disk utilization may be unable to save new data, and a server device with high processor utilization may be slow and behave in unpredictable ways. Thus, it is important for an enterprise to be able to forecast the future usage of these devices in order to maintain their proper operational states. This maintenance may involve adding computing resources (e.g., more processing, memory, disk, or network capacity) ahead of when the forecasts indicate that the usage is predicted to be high enough to degrade performance. Even cloud-based systems used by the enterprise can benefit from forecasting, as it can provide suggestions of when to allocate more physical or virtual machines, clusters, nodes, and so on.

It is relevant to point out that usage patterns of computer resources may vary, and the forecasting herein can identify different patterns. For example, disk usage tends to grow over time as more and more data is stored. Thus, a high forecasted disk usage can be addressed by archiving data to long-term storage or adding more disk capacity.

On the other hand, processor, memory, and network usage may also grow over time, but is more likely to be dominated by some sort of cyclic behavior, such as a diurnal or weekly cycle. In a diurnal cycle, as one possibility, usage may increase through the morning hours, peak in the early afternoon, and then decrease in the late afternoon until a low point is reached during overnight hours. Notably, different types of applications may result in different diurnal or weekly patterns. For example, productivity applications may exhibit increased usage during certain hours of the work week (e.g., 9 am-5pm, Monday through Friday) whereas entertainment applications may exhibit increased usage in the evening and weekend hours. Regardless, forecasts involving cyclic usage patterns can be used to identify peak utilizations and to provision resources to meet peak demand.

Not unlike computing resources, usage of other types of resources can be forecasted in a similar fashion. For example, many enterprises employ some form of help desk at which technology users can request assistance from agents regarding the use of enterprise computing systems. Help desks may have various channels, including incidents (e.g., trouble tickets raised by technology users), chats (real-time messaging between technology users and agents), and walk-up kiosks (physical locations within the enterprise premises at which a technology user can request assistance in person). Other channels, such as email and phone calls, may be supported. Help desk usage may have diurnal and weekly cycles, and may also trend upward or downward over time.

In order to meet the operational requirements of an enterprise, accurate forecasting is desirable. Such forecasts can be used to allocate or deallocate resources in a manner such that demand can be met without too many resources being idle. Thus, problems associated with over-allocation or under-allocation can be mitigated or avoided.

Forecasting involves collecting data representing past resource usage over a period of time (the collection period), performing one or more forecasting algorithms on this data, and then predicting the usage of the same resources over a future period of time (the forecast period). The data may be collected from database tables, log files, records of worked time, or other data sources of a remote network management platform. The forecasting may involve definition of one or more cycle lengths (e.g., 24 hours or 168 hours) over which patterns are expected to repeat. Thus, a forecasting application may take as input: (i) the collected data, (ii) a definition of the collection period, (iii) definitions of one or more cycles within the collected data, (iv) one or more forecasting algorithms, and (v) a definition of the forecast period. The forecasting application may then apply the forecasting algorithm(s) to the collected data in view of the cycle(s).

As a simple example, suppose that the collected data represents five weeks of processor utilization collected hourly from a server device, the collection period began on a Sunday and ended on a Saturday, and a cycle is defined to be a week in length. Thus, the data represents 24 hourly measurements of processor utilization for each Sunday, Monday, Tuesday, and so on of the collection period.

A simple forecasting algorithm may calculate the mean processor utilization for each hour of the cycle and project these calculations to the forecast period. To illustrate suppose that the measured processor utilization for 9 am Monday in each week is respectively 50%, 53%, 55%, 60%, and 57%. The mean value for the collected data at the 9 am Monday time period is 55%. Thus, the forecasted values for the each Monday at 9 am in the forecast period would be 55%. A slightly more sophisticated forecasting algorithm may use a form of linear regression to find that the collected data can be modeled with a trend line of y=2.1x +48.7. Thus, assuming that the forecast period is the three-week period following the collection period, the forecasted values for processor utilization at 9 am Monday will be 61.3%, 63.4%, and 65.5%, respectively. Distinct forecasts can also be made for processor utilization at different points in the forecast period (e.g., 10am Monday, 9 am Tuesday, 11pm Thursday, etc.).

More sophisticated forecasting algorithms may be used. As noted, a “linear” algorithm may generate a linear-regression-based forecast from the collected data. A “drift” algorithm may generate a forecast starting with the value of the last observation in the collected data, and then increase or decrease the value over time. The amount of this change (the drift) is based on the average change observed in the collected data. A “naive seasonal” algorithm may generate a forecast that is a copy of the previous season of collected data. This method does not consider trend data beyond the previous season, such as increasing scores season over season. A “season” for this analysis may be one collection period. A “naive seasonal drift” algorithm may generate a forecast that starts as a copy of the previous “season” of collected data. The forecast increases or decreases over time, where the amount of change over time (the drift) is set as the average season over season change in the collected data. A “seasonal trend loss” algorithm may generate a forecast based on a best-fit function, trend data, and a filter to exclude noise from random variation in the collected data.

Other forecasting algorithms exist and may be used with the embodiments herein. For example, any of the above algorithms may be modified to account for holidays, regardless of the day of the week on which they fall. Thus, for example, resource demand may be lower than usual on New Year's Day or Christmas. Further, the user may be presented with an “auto” option that automatically selects an algorithm based on the collected data.

Once a forecast is obtained, it can be used to modify resource allocation. For example, if a computing system is forecast to reach 90% processor utilization within the next week, a remote network management platform may be arranged to automatically suggest or add more processing resources (e.g., physical or virtual machines) to the system. Alternatively, the remote network management platform may be arranged to automatically suggest or distribute incoming jobs load to a different set of processing resources. If the resources are agents, the remote network management platform may be arranged to automatically suggest or add more virtual agents or change the work hours or allocation of agents to tasks in order to better accommodate demand.

Nonetheless, current forecasting techniques are limited in scope. Particularly, even the most robust algorithms can suffer from inaccuracies. For instance, an algorithm can be consistently off by 10% or 20% when forecasts are compared to actual resource utilization during the forecast period. Also, forecasting typically cannot accommodate anomalous spikes in demand due to upcoming events. For example, a release of a new movie on a streaming service may cause a significant increase in demand in certain data centers during its first weekend of availability. Likewise, a new software release may cause a significant increase in help desk demand during the first 2-3 days of its availability.

These anomalous events are often known or predictable, but are not discernable from historical data. Consequently, current forecasting techniques are unable to address such events largely because these techniques are static and do not allow dynamic customization of the forecasting parameters by a user. The embodiments herein overcome these and possibly other problems by providing a flexible, user-customizable, real-time forecasting system that is able to adapt to pervasive algorithm inaccuracies as well as anomalous demand changes.

A. Forecasting Examples

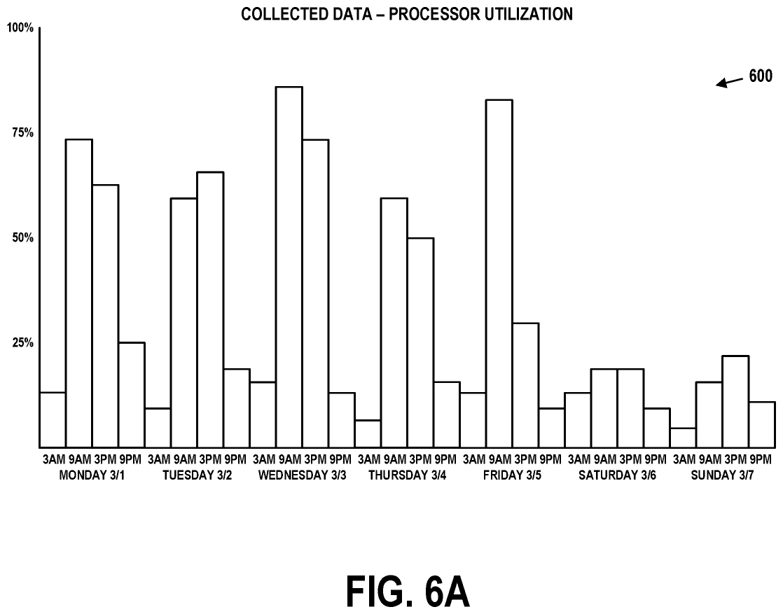

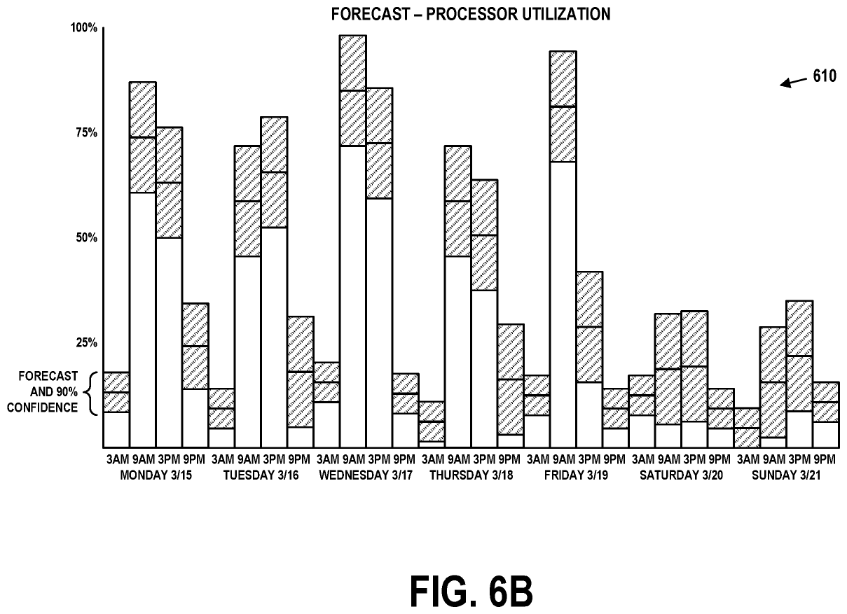

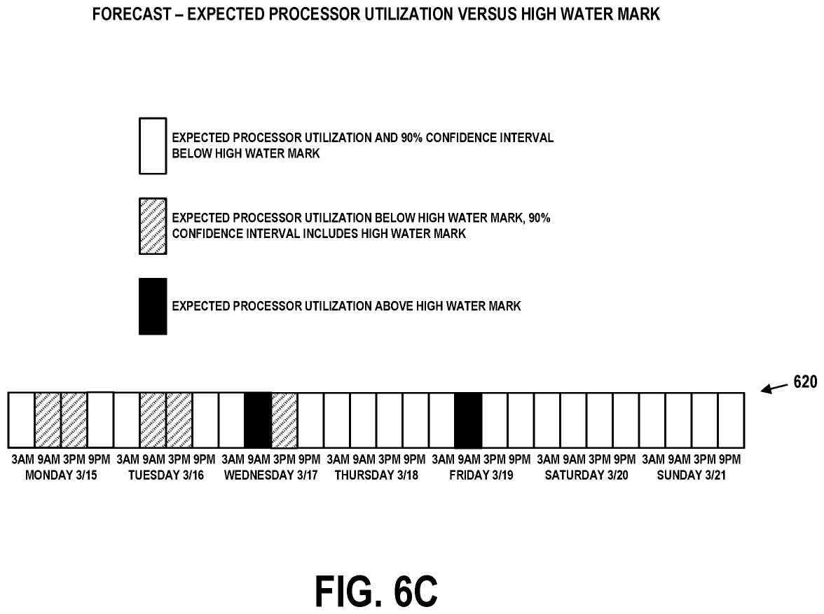

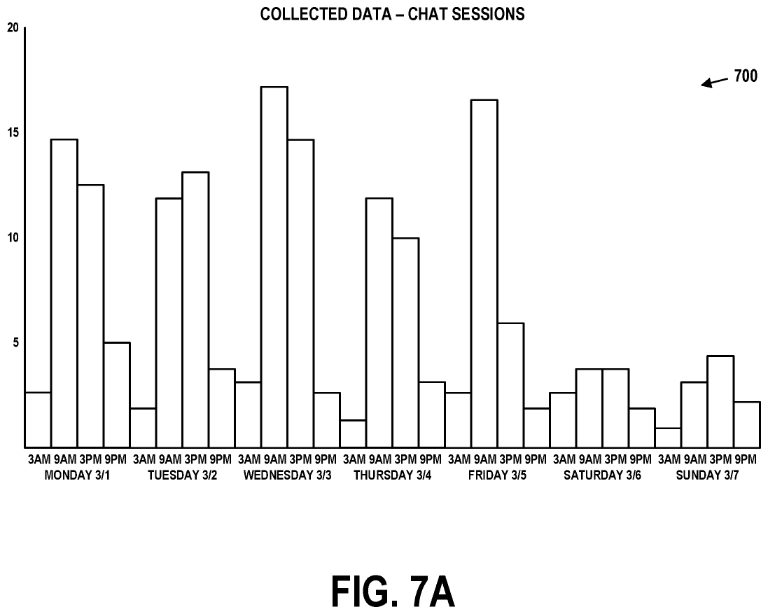

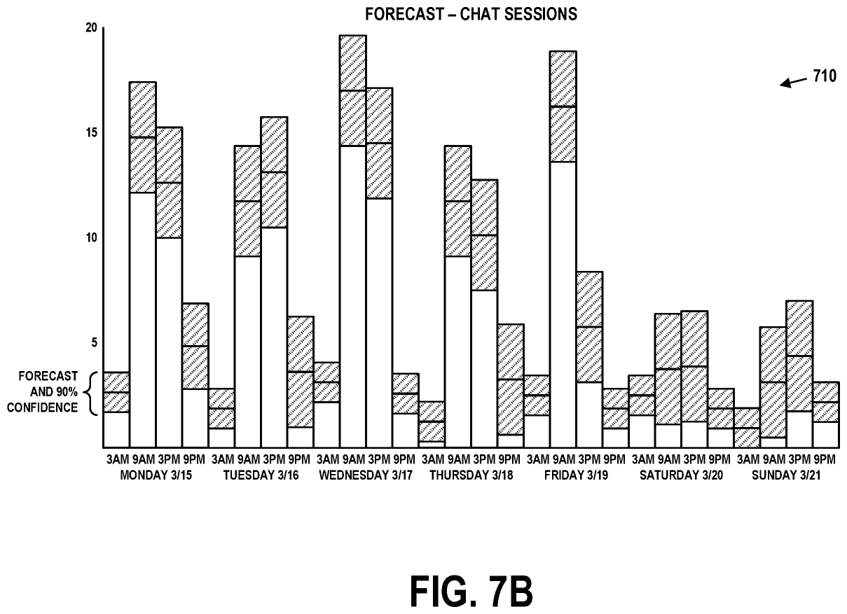

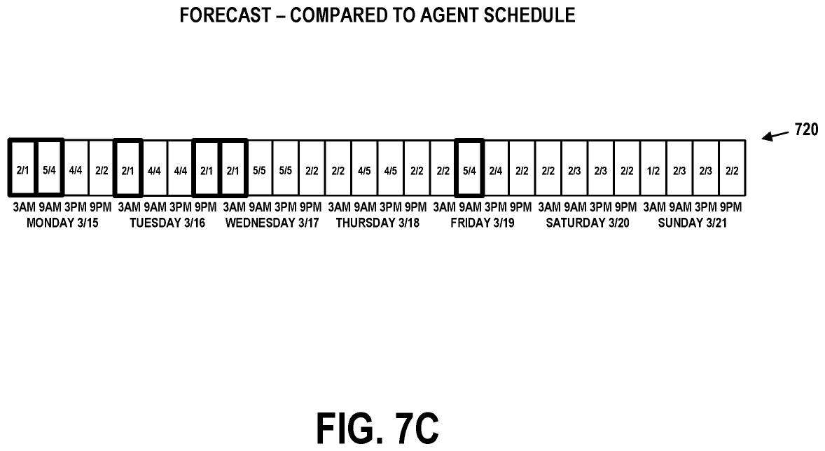

FIGS. 6A-7C provide visual examples of forecasting, in accordance with various embodiments. These examples illustrate how forecasting can be used for processor utilization and agent workload, respectively. But as noted above, the utilization of many other types of resources can be forecast in a similar manner.

FIG. 6A depicts a week of collected data (Monday, Mar. 1, 2021 through Sunday, Mar. 7, 2021) relating to processor utilization (measured in percent of processor capacity) in bar chart 600. For purposes of simplicity and illustration, it is assumed that processor utilization is measured once every 6 hours, at 3 am, 9 am, 3 pm, and 9 pm of each day. But in actual embodiments, it is expected that processor utilization would be measured more frequently, such as every 5 or 15 minutes.

The data of bar chart 600 depicts both a daily and a weekly cycle. Notably, processor utilizations at 3 am and 9 pm are typically lower than processor utilizations at 9 am and 3 pm. This is likely due to more applications being executed during normal work hours than during overnight hours. This cycle is less pronounced on Saturday and Sunday, indicating that these applications are used relatively lightly on weekends.

Regarding the values of the collected data, some measurements indicate that processor utilization is quite high. For example, the processor utilizations at 9 am Wednesday and 9 am Friday both meet or exceed 80%. A processor utilization this high often results in at least some applications, requests, or associated processing operating slowly. But other high watermark values may be used instead of 80%.

While bar chart 600 depicts just one week of collected data, there may be several weeks of such data collected that can be used to produce forecasts (e.g., the collection period may be 5 weeks ending on Mar. 7, 2021). Thus, the time frame represented in bar chart 600 is intentionally short for purposes of simplicity and illustration. Nonetheless, several weeks of collected data, including that which is not shown in bar chart 600, may be used for forecasting.

Bar chart 600 may be generated by a computational instance of a remote network management platform, and provided for viewing on a graphical user interface. The graphical user interface may be interactive, in that it allows different start and end dates of the collection period to be specified for display. The graphical user interface may also allow a user to select a forecast period, forecasting algorithm, and a date range of the collected data with which to generate the forecast.

To that point, FIG. 6B depicts a week of forecasted data (Monday, Mar. 15, 2021 through Sunday, Mar. 21, 2021) relating to processor utilization in bar chart 610. As noted, these forecasts can be based on various algorithms, such as the linear, drift, naive seasonal, naive seasonal drift, or seasonal trend loss algorithms described above. Here, it is assumed that this forecast is being carried out during the week of Mar. 8, 2021 to forecast processor utilization in the coming week. But other time frames are possible. Bar chart 610 may be generated by a computational instance of a remote network management platform, and provided for viewing on a graphical user interface.

Bar chart 610 provides forecasts of projected processor utilization for each measurement time in the collected data (3 am, 9 am, 3 pm, and 9 pm of each day). As shown, each forecast is represented by a forecast value and a 90% confidence interval. The confidence interval appears as a hashmarked region in each bar centered on the forecast value. For example, the forecast value for 3 am Monday is shown as approximately 13% with a confidence interval that ranges from 9% to 17%. The confidence interval may be calculated based on the forecasted value as well as the volume and variability of the associated collected data.

As shown in bar chart 610, several forecasted values meet or exceed 80% processor utilization, and several others exhibit a 90% confidence interval that includes 80% processor utilization. This suggests that, for at least some specific points in time during the week of Mar. 15, 2021 through Mar. 21, 2021, processor utilization is expected to be problematically high.

To simplify the identification of points in time that are expected to have high processor utilization, FIG. 6C depicts expected processor utilization versus the high watermark of 80% for each forecasted value in timeline 620. Each forecasted value is represented in white if the expected processor utilization and its 90% confidence interval are below the high watermark, with hashmarks if the expected processor utilization is below the high watermark but its 90% confidence interval includes the high watermark, and black if the expected processor utilization is above the high watermark.

Timeline 620 allows the user to easily identify the periods during which processor utilization is expected to be problematic enough to impact performance, as well as the expected magnitude of this impact. Timeline 620 may be generated by a computational instance of a remote network management platform, and provided for viewing on a graphical user interface. Based on the information in timeline 620, the user may decide to allocate more processing resources to the system under review, or the remote network management platform may automatically scale processing resources accordingly (e.g., adding more physical or virtual machines) at least during the periods of timeline 620 during which processor utilization is represented as being high.

FIGS. 7A, 7B, and 7C provide a further example of forecasting for a different data type—expected volume of chat sessions. As noted above, a chat session is how some technology users may request assistance from agents.

FIG. 7A depicts a week of collected data (Monday, Mar. 1, 2021 through Sunday, Mar. 7, 2021) relating to chat session volume (e.g., the number of chat sessions initiated) in bar chart 700. For purposes of simplicity and illustration, it is assumed that chat session volume is measured once every 6 hours, at 3 am, 9 am, 3 pm, and 9 pm of each day. But in actual embodiments, it is expected that chat session volume would be measured more frequently, such as every hour.

While bar chart 700 depicts just one week of collected data, there may be several weeks of such data collected that can be used to produce forecasts (e.g., the collection period may be 5 weeks ending on Mar. 7, 2021). Thus, the time frame represented in bar chart 700 is intentionally short for purposes of simplicity and illustration. Nonetheless, several weeks of collected data, including that which is not shown in bar chart 700, may be used for forecasting.

Like bar chart 600, bar chart 700 may be generated by a computational instance of a remote network management platform, and provided for viewing on a graphical user interface. The graphical user interface may be interactive, in that it allows different start and end dates of the collection period to be specified for display. The graphical user interface may also allow a user to select a forecast period, forecasting algorithm, and a date range of the collected data with which to generate the forecast

To that point, FIG. 7B depicts a week of forecasted data (Monday, Mar. 15, 2021 through Sunday, Mar. 21, 2021) relating to chat session volume in bar chart 710. As noted, these forecasts can be based on various algorithms, such as the linear, drift, naive seasonal, naive seasonal drift, or seasonal trend loss algorithms described above. Here, it is assumed that this forecast is being carried out during the week of Mar. 8, 2021 to forecast chat session volume in the coming week. But other time frames are possible. Bar chart 710 may be generated by a computational instance of a remote network management platform, and provided for viewing on a graphical user interface.

Bar chart 710 provides forecasts of projected chat session volume for each measurement time in the collected data (3 am, 9 am, 3 pm, and 9 pm of each day). As shown, each forecast is represented by a forecast value and a 90% confidence interval. The confidence interval appears as a hashmarked region in each bar centered on the forecast value. For example, the forecast value for 9 am Monday is shown as approximately 3 with a confidence interval that ranges from 2.5 to 3.5. The confidence interval may be calculated based on the forecasted value as well as the volume and variability of the associated collected data.

Unlike processor utilization, which has a range with a clearly-defined maximum value (100%), chat session volume may not have a fixed upper bound. For example, it is possible for chat session volume to exceed the y-axis range of bar chart 710 by an order of magnitude or more. Further, chat session volume, on its own, is not necessarily indicative of when agent resources are under-allocated—expected chat session length and agent schedules should also be considered.

Put another way, for a given time period i with a length of lᵢ minutes, forecasted chat session volume (e.g., number of incoming chat sessions) can be represented as vᵢ and the number of agents scheduled can be represented as aᵢ . Expected chat session length can be represented as c minutes, a value that is constant across time periods. Therefore, the number of agent-minutes expected to be required in time period i is vᵢ×c. The number of scheduled agent-minutes is aᵢ×lᵢ. Thus, as long as the relationship aᵢ×lᵢ≥vᵢ×c holds, sufficient agent resources are scheduled during the time period.

As a concrete example, suppose that vᵢ=10, c=15, aᵢ=2, and lᵢ=60. Then, a total of 150 agent minutes is needed but only 120 agent minutes are available. Alternatively, these agent-minute values can be divided by lᵢ=60 to determine the number of required agents (3) and the number of scheduled agents (2). This latter representation clearly indicates the number of additional agents needed as the number of required agents minus the number of scheduled agents.

In addition or alternatively to chat session volume, other help desk metrics, such as incident volume, phone call volume, and/or walk-up volume may be addressed in a similar fashion. Other enterprise or operational characteristics may be collected and forecasted as well.

To simplify the identification of points in time that are expected to have insufficient agent resources, FIG. 7C depicts, in timeline 720, expected the number of required agents (x) and the number of scheduled agents (y) in the format (x/y) for each forecasted time period. It is assumed that c=15 and lᵢ=60. Each time period for which the number of required agents exceeds the number of scheduled agents is highlighted with thicker surrounding lines.

Timeline 720 allows the user to easily identify the periods during which there are insufficient agent resources. Timeline 720 may be generated by a computational instance of a remote network management platform, and provided for viewing on a graphical user interface. Based on the information in timeline 720, the user may decide to schedule more agents in at least some of the highlighted time periods.

B. Forecasting User Interfaces and Dynamic, Real-Time Adjusted Forecasts

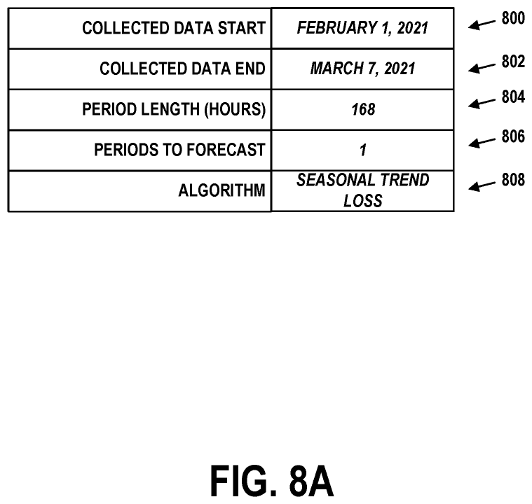

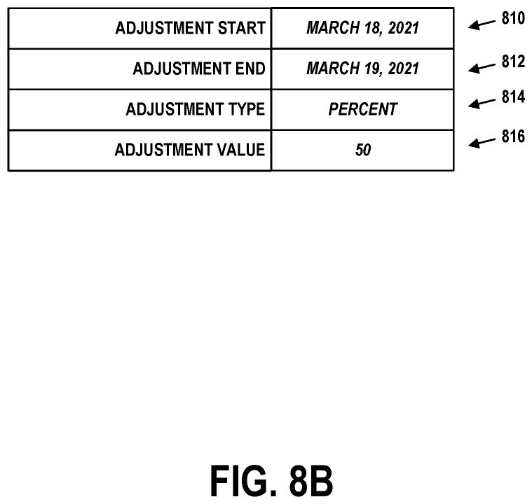

FIG. 8A depicts a graphical user interface for specifying a forecast based on a set of collected data. It is assumed that the collected data has already been specified (e.g., by way of a reference to a database table or log file, for instance) and thus how to access it is known. Particularly, FIG. 8A shows five user-controllable forecast parameters. In various embodiments, more or fewer parameters may exist.

Parameter 800 is the start date for considering the collected data, and parameter 802 is the end date for considering the collected data. It is assumed that each unit of the collected data is associated with a timestamp so that its date is known. Thus, parameters 800 and 802, in combination, select all of the collected data between Feb. 1, 2021 and Mar. 7, 2021. Collected data outside of this range may exist, but only the collected data within this date range is used as the basis of the forecast.

Parameter 804 defines the period length in terms of hours. This allows specification of one period for purposes of forecasting. The period is expected to represent a cycle (e.g., daily, weekly, monthly, or otherwise) during which patterns in the collected data repeat. In the example of FIG. 8A, the period is set to 168 hours (one week).

Parameter 806 defines the number of periods to forecast. In the example of FIG. 8A, this is 1 period, equating to 1 week based on the definition of parameter 804.

Parameter 808 defines the forecasting algorithm. In the example of FIG. 8A, this is seasonal trend loss.

Once these parameters are specified, the graphical user interface may allow the user to actuate a button to generate the forecast. Depending on the values of parameters 800, 802, 804, 806, and 808 this could take a few seconds or more, but the forecast can be generated and displayed in real time. Thus, the graphical user interface of FIG. 8A may be used to generate the forecasts depicted in FIG. 6B and/or FIG. 7B, for example. This graphical user interface could be integrated with that of FIG. 6A and/or FIG. 7A.

FIG. 8B depicts a graphical user interface for specifying an adjustment to a forecast. It is assumed that the collected data has already been specified (e.g., by way of a reference to a database table or log file, for instance) and a forecast has already been performed. Alternatively, the adjustment can be made before a forecast is performed and based on specified forecast parameters, such as those of FIG. 8A. Regardless, FIG. 8B shows four user-controllable forecast adjustment parameters. In various embodiments, more or fewer parameters may exist.

Parameter 810 is the start date for the adjustment period, and parameter 812 is the end date for the adjustment period. It is assumed that the adjustment period is within the range of data for which a forecast has been or is to be generated. In FIG. 8B, the adjustment period is Mar. 18, 2021 through Mar. 19, 2021.

Parameter 814 defines the adjustment type. For example, the adjustment type can be a fixed offset that is added to or subtracted from the forecasted values within the adjustment period. Alternatively, and as shown in FIG. 8B, the adjustment type can be a percentage that is used to scale the forecasted values within the adjustment period up or down. In FIG. 8B, the adjustment type is percent.

Parameter 816 defines the adjustment value. When the adjustment type is a fixed offset, this is the value of the offset. When the adjustment type is percent, this value is the percent. In FIG. 8B, the adjustment value is 50, which in combination with parameter 814, indicates that the forecasted values in the adjustment period are to be scaled up by 50%.

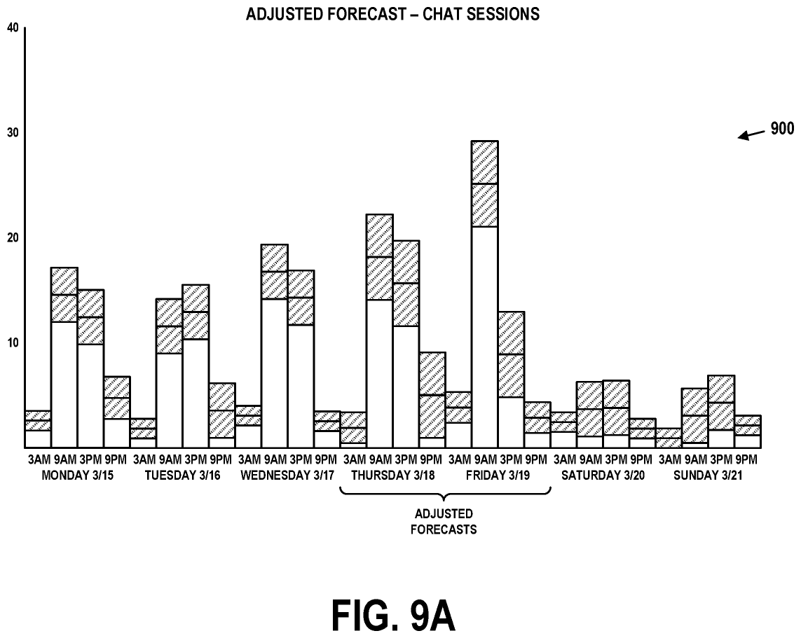

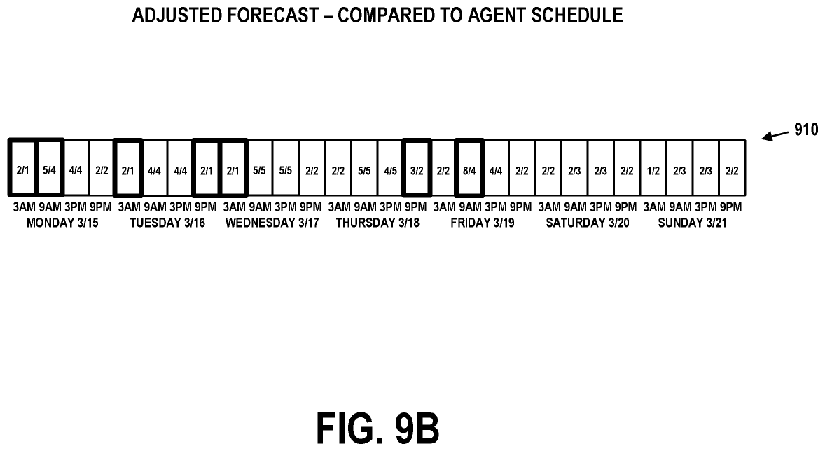

Once these parameters are specified, the graphical user interface may allow the user to actuate a button to generate the adjusted forecast. Depending on the values of parameters 810, 812, 814, and 816, this could take a few seconds or more, but the adjusted forecast can be generated and displayed in real time. The graphical user interface of FIG. 8B may be used to generate the forecasts depicted in FIG. 9A (below), for example. This graphical user interface could be integrated with that of FIG. 6B and/or FIG. 7B.

Advantageously, allowing a user to dynamically adjust forecasts in this manner permits the user to enter various adjustment parameters and see their impact on the forecast in real time. Further, these adjustments may reflect the impact of anomalous events that cannot be predicted from the collected data.

FIG. 9A depicts the forecast bar chart of FIG. 7B adjusted in accordance with the parameters of FIG. 8B. Thus, for the entries of Mar. 18, 2020 and Mar. 19, 2021 in bar chart 900, a scaling up of 50% has been applied. Note that the range of the y-axis has been modified to accommodate this scaling. The confidence intervals may be re-calculated accordingly.

FIG. 9B depicts timeline 910, which is a version of timeline 720 modified to reflect the adjusted forecast of FIG. 9A. In timeline 910, the expected the number of required agents (x) and the number of scheduled agents (y) are presented in the format (x/y) for each forecasted time period. Again, it is assumed that c=15 and lᵢ=60, and each time period for which the number of required agents exceeds the number of scheduled agents is highlighted with thicker surrounding lines.

The main difference of note between timeline 720 and timeline 910 is that the latter indicates that there are not enough agents allocated for the periods of 9 pm Thursday and 9 am Friday. In particular, 9 pm Thursday requires 3 agents while only 2 are allocated, and 9 am Friday require 8 agents while only 4 are allocated.

An advantage of FIGS. 9A and 9B is that they allow the user to clearly understand how an adjusted forecast can impact agent coverage during the adjusted period. The user can easily determine how many agents are under-allocated or over-allocated, and then take measures to change the agents' schedules if desired.

Similar advantages exist when considering adjusted resources of computing resource utilization as well. A user might generated an adjusted forecast and then authorize an automatic provisioning of more or less resources during the adjusted period.

C. Saving and Publishing Forecasts

Once a draft forecast has been specified (e.g., with the parameters of FIGS. 8A and 8B), it can be performed and its results considered. The draft forecast may be edited or further adjusted until it is deemed satisfactory for its purpose. Then it can be published so that it can be performed on an automatic basis going forward (e.g., daily) or manually. Published forecasts can be unpublished to revert them back to the draft state.

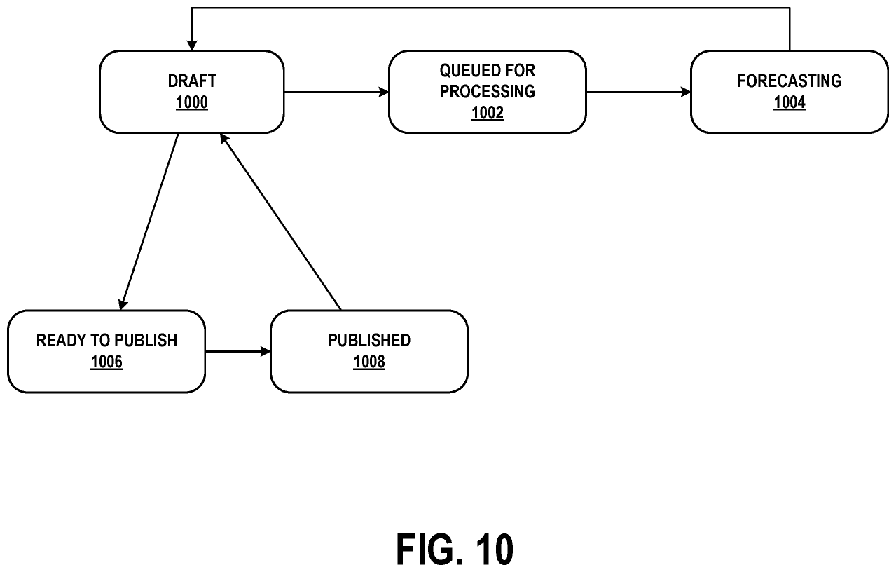

FIG. 10 depicts a flow chart illustrating such a process. In block 1000, the forecast has been specified and is in the draft state. A user can test its operation by requesting that it be performed (e.g., by way of a graphical user interface button). Doing so queues the forecast for processing, as represented by block 1002. When queued, the forecast is waiting for the system (e.g., the remote network management platform) to select it for processing. The graphical user interface may display an indication of progress to maintain the real time nature of the forecast.

Block 1004 represents the forecast being performed. The results may be stored (e.g., in a database table), and/or displayed on a graphical user interface. The user can view these results, and further modify the forecast if desired. To that point, the user might iterate through several cycles of blocks 1000, 1002, and 1004 until the forecast is performing as desired.

When publication of a draft forecast is requested, the forecast transitions to the ready to publish state, as represented by block 1006. In this state, the forecast is performed so that its results are available. Once these results are available, the forecast transitions to the published state, as represented by block 1008. In this state, the forecast can be automatically performed on a regular basis (e.g., daily) as well as manually.

### VI. Example Operations

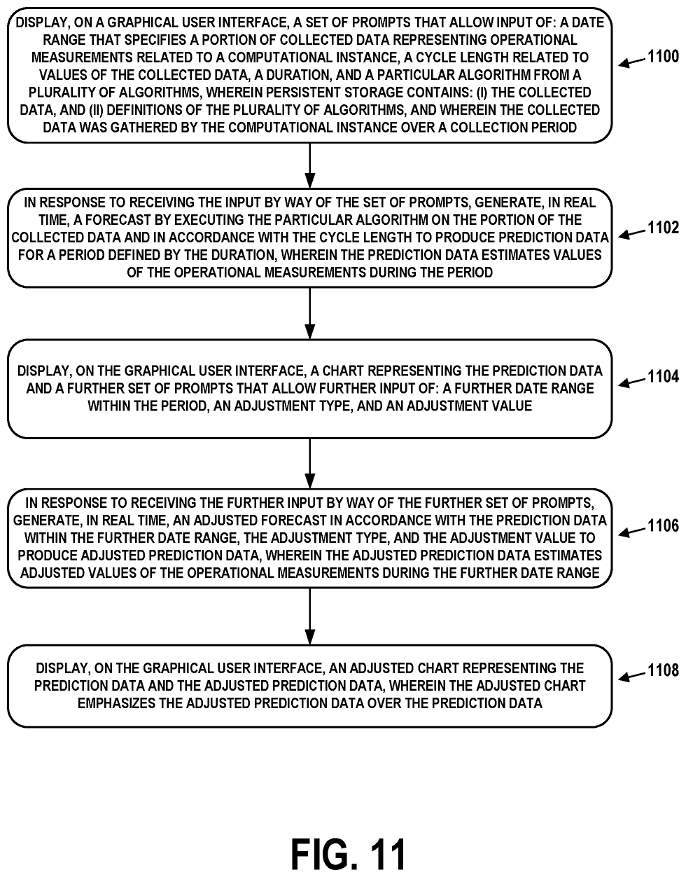

FIG. 11 is a flow chart illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1100 may involve displaying, on a graphical user interface, a set of prompts that allow input of: a date range that specifies a portion of collected data representing operational measurements related to a computational instance, a cycle length related to values of the collected data, a duration, and a particular algorithm from a plurality of algorithms, wherein persistent storage contains: (i) the collected data, and (ii) definitions of the plurality of algorithms, and wherein the collected data was gathered by the computational instance over a collection period.

Block 1102 may involve, possibly in response to receiving the input by way of the set of prompts, generating, in real time, a forecast by executing the particular algorithm on the portion of the collected data and in accordance with the cycle length to produce prediction data for a period defined by the duration, wherein the prediction data estimates values of the operational measurements during the period.

Block 1104 may involve displaying, on the graphical user interface, a chart representing the prediction data and a further set of prompts that allow further input of: a further date range within the period, an adjustment type, and an adjustment value.

Block 1106 may involve, possibly in response to receiving the further input by way of the further set of prompts, generating, in real time, an adjusted forecast in accordance with the prediction data within the further date range, the adjustment type, and the adjustment value to produce adjusted prediction data, wherein the adjusted prediction data estimates adjusted values of the operational measurements during the further date range.

Block 1108 may involve displaying, on the graphical user interface, an adjusted chart representing the prediction data and the adjusted prediction data, wherein the adjusted chart emphasizes the adjusted prediction data over the prediction data.

In some embodiments, the graphical user interface displays, along with the adjusted chart, the further set of prompts that allow second further input of: a second further date range within the period, a second adjustment type, and a second adjustment value. These embodiments may further involve (i) possibly in response to receiving the second further input by way of the further set of prompts, generating, in real time, a second adjusted forecast in accordance with the prediction data within the second further date range, the second adjustment type, and the second adjustment value to produce second adjusted prediction data, wherein the second adjusted prediction data estimates second adjusted values of the operational measurements during the second further date range; and (ii) displaying, on the graphical user interface, a second adjusted chart representing the prediction data and the second adjusted prediction data, wherein the second adjusted chart emphasizes the second adjusted prediction data over the prediction data.

In some embodiments, generating the forecast in real time comprises: queueing, by the computational instance, the forecast for processing; and selecting, by the computational instance, the forecast for processing, wherein the graphical user interface displays a progress indicator while the forecast is queued and processed.

Some embodiments may involve storing the date range, the cycle length, the duration, the particular algorithm, the further date range, the adjustment type, and the adjustment value as published forecast parameters, wherein the computational instance is configured to automatically re-generate the forecast on a regular basis.

In some embodiments, the collected data represents utilization of computing resources on a managed network that is associated with the computational instance. These embodiments may further involve generating a timeline from the adjusted prediction data that emphasizes when the utilization of the computing resources meets or exceeds a predefined high watermark; and displaying, on the graphical user interface, the timeline. The computing resources may include one or more of processing resources, memory resources, disk resources, or networking resources.

In some embodiments, the collected data represents request volume for agents that are associated with the computational instance. These embodiments may involve generating a timeline from the adjusted prediction data and a capacity schedule for the agents, wherein the timeline emphasizes when the request volume exceeds agent capacity as specified in the capacity schedule; and displaying, on the graphical user interface, the timeline. The request volume for agents may relate to one or more of incident request volume, chat session request volume, phone request volume, or walk-up request volume.

In some embodiments, the plurality of algorithms include two or more of a linear-regression-based algorithm, a drift-based algorithm, a naive seasonal algorithm, a naive seasonal drift algorithm, or a seasonal trend loss algorithm.

In some embodiments, the adjustment type is a fixed offset and the adjustment value is a value of the fixed offset, wherein the adjusted values of the operational measurements during the further date range are based on the value of the fixed offset applied to the values of the operational measurements during the further date range.

In some embodiments, the adjustment type is a percent and the adjustment value is a value of the percent, wherein the adjusted values of the operational measurements during the further date range are based on scaling the values of the operational measurements during the further date range by the value of the percent.

### VII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long-term storage, like ROM, optical or magnetic disks, solid-state drives, or compact disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing: (i) collected data representing operational measurements related to a computational instance, and (ii) definitions of a plurality of algorithms, wherein the collected data was gathered by the computational instance over a collection period; and
one or more processors configured to:
display, on a graphical user interface, a set of prompts that allow input of: a date range that specifies a portion of the collected data, a cycle length related to values of the collected data, a duration, and a particular algorithm from the plurality of algorithms;
in response to receiving the input by way of the set of prompts, generate, in real time, a forecast by executing the particular algorithm on the portion of the collected data and in accordance with the cycle length to produce prediction data for a period defined by the duration, wherein the prediction data estimates values of the operational measurements during the period;
display, on the graphical user interface, a chart representing the prediction data and a further set of prompts that allow further input of: a further date range within the period, an adjustment type, and an adjustment value;
in response to receiving the further input by way of the further set of prompts, generate, in real time, an adjusted forecast in accordance with the prediction data within the further date range, the adjustment type, and the adjustment value to produce adjusted prediction data, wherein the adjusted prediction data estimates adjusted values of the operational measurements during the further date range; and
display, on the graphical user interface, an adjusted chart representing the prediction data and the adjusted prediction data, wherein the adjusted chart emphasizes the adjusted prediction data over the prediction data.

2. The system of claim 1, wherein the graphical user interface displays, along with the adjusted chart, the further set of prompts that allow second further input of: a second further date range within the period, a second adjustment type, and a second adjustment value, and wherein the one or more processors are further configured to:
in response to receiving the second further input by way of the further set of prompts, generate, in real time, a second adjusted forecast in accordance with the prediction data within the second further date range, the second adjustment type, and the second adjustment value to produce second adjusted prediction data, wherein the second adjusted prediction data estimates second adjusted values of the operational measurements during the second further date range; and
display, on the graphical user interface, a second adjusted chart representing the prediction data and the second adjusted prediction data, wherein the second adjusted chart emphasizes the second adjusted prediction data over the prediction data.

3. The system of claim 1, wherein generating the forecast in real time comprises:
queueing, by the computational instance, the forecast for processing; and
selecting, by the computational instance, the forecast for processing, wherein the graphical user interface displays a progress indicator while the forecast is queued and processed.

4. The system of claim 1, wherein the one or more processors are further configured to store the date range, the cycle length, the duration, the particular algorithm, the further date range, the adjustment type, and the adjustment value as published forecast parameters, and wherein the computational instance is configured to automatically re-generate the forecast on a regular basis.

5. The system of claim 1, wherein the collected data represents utilization of computing resources on a managed network that is associated with the computational instance.

6. The system of claim 5, wherein the one or more processors are further configured to:
generate a timeline from the adjusted prediction data that emphasizes when the utilization of the computing resources exceeds a predefined high watermark; and
display, on the graphical user interface, the timeline.

7. The system of claim 5, wherein the computing resources include one or more of processing resources, memory resources, disk resources, or networking resources.

8. The system of claim 1, wherein the collected data represents request volume for agents that are associated with the computational instance.

9. The system of claim 8, wherein the one or more processors are further configured to:
generate a timeline from the adjusted prediction data and a capacity schedule for the agents, wherein the timeline emphasizes when the request volume exceeds agent capacity as specified in the capacity schedule; and
display, on the graphical user interface, the timeline.

10. The system of claim 8, wherein the request volume for agents relates to one or more of incident request volume, chat session request volume, phone request volume, or walk-up request volume.

11. The system of claim 1, wherein the plurality of algorithms include two or more of a linear-regression-based algorithm, a drift-based algorithm, a naïve seasonal algorithm, a naïve seasonal drift algorithm, or a seasonal trend loss algorithm.

12. The system of claim 1, wherein the adjustment type is a fixed offset and the adjustment value is a value of the fixed offset, and wherein the adjusted values of the operational measurements during the further date range are based on the value of the fixed offset applied to the values of the operational measurements during the further date range.

13. The system of claim 1, wherein the adjustment type is a percent and the adjustment value is a value of the percent, and wherein the adjusted values of the operational measurements during the further date range are based on scaling the values of the operational measurements during the further date range by the value of the percent.

14. A computer-implemented method comprising:
displaying, on a graphical user interface, a set of prompts that allow input of: a date range that specifies a portion of collected data representing operational measurements related to a computational instance, a cycle length related to values of the collected data, a duration, and a particular algorithm from a plurality of algorithms, wherein persistent storage contains: (i) the collected data, and (ii) definitions of the plurality of algorithms, and wherein the collected data was gathered by the computational instance over a collection period;
in response to receiving the input by way of the set of prompts, generating, in real time, a forecast by executing the particular algorithm on the portion of the collected data and in accordance with the cycle length to produce prediction data for a period defined by the duration, wherein the prediction data estimates values of the operational measurements during the period;
displaying, on the graphical user interface, a chart representing the prediction data and a further set of prompts that allow further input of: a further date range within the period, an adjustment type, and an adjustment value;
in response to receiving the further input by way of the further set of prompts, generating, in real time, an adjusted forecast in accordance with the prediction data within the further date range, the adjustment type, and the adjustment value to produce adjusted prediction data, wherein the adjusted prediction data estimates adjusted values of the operational measurements during the further date range; and
displaying, on the graphical user interface, an adjusted chart representing the prediction data and the adjusted prediction data, wherein the adjusted chart emphasizes the adjusted prediction data over the prediction data.

15. The computer-implemented method of claim 14, wherein generating the forecast in real time comprises:
queueing, by the computational instance, the forecast for processing; and
selecting, by the computational instance, the forecast for processing, wherein the graphical user interface displays a progress indicator while the forecast is queued and processed.

16. The computer-implemented method of claim 14, further comprising:
storing the date range, the cycle length, the duration, the particular algorithm, the further date range, the adjustment type, and the adjustment value as published forecast parameters, wherein the computational instance is configured to automatically re-generate the forecast on a regular basis.

17. The computer-implemented method of claim 14, wherein the collected data represents utilization of computing resources on a managed network that is associated with the computational instance, the computer-implemented method further comprising:
generating a timeline from the adjusted prediction data that emphasizes when the utilization of the computing resources meets or exceeds a predefined high watermark; and
displaying, on the graphical user interface, the timeline.

18. The computer-implemented method of claim 14, wherein the collected data represents request volume for agents that are associated with the computational instance, the computer-implemented method further comprising:
generating a timeline from the adjusted prediction data and a capacity schedule for the agents, wherein the timeline emphasizes when the request volume exceeds agent capacity as specified in the capacity schedule; and
displaying, on the graphical user interface, the timeline.

19. The computer-implemented method of claim 14, wherein the adjustment type is a percent and the adjustment value is a value of the percent, and wherein the adjusted values of the operational measurements during the further date range are based on scaling the values of the operational measurements during the further date range by the value of the percent.

20. An article of manufacture including a non-transitory computer-readable medium, having stored thereon program instructions that, upon execution by a computing system, cause the computing system to perform operations comprising:
displaying, on a graphical user interface, a set of prompts that allow input of: a date range that specifies a portion of collected data representing operational measurements related to a computational instance, a cycle length related to values of the collected data, a duration, and a particular algorithm from a plurality of algorithms, wherein persistent storage contains: (i) the collected data, and (ii) definitions of the plurality of algorithms, and wherein the collected data was gathered by the computational instance over a collection period;
in response to receiving the input by way of the set of prompts, generating, in real time, a forecast by executing the particular algorithm on the portion of the collected data and in accordance with the cycle length to produce prediction data for a period defined by the duration, wherein the prediction data estimates values of the operational measurements during the period;
displaying, on the graphical user interface, a chart representing the prediction data and a further set of prompts that allow further input of: a further date range within the period, an adjustment type, and an adjustment value;
in response to receiving the further input by way of the further set of prompts, generating, in real time, an adjusted forecast in accordance with the prediction data within the further date range, the adjustment type, and the adjustment value to produce adjusted prediction data, wherein the adjusted prediction data estimates adjusted values of the operational measurements during the further date range; and
displaying, on the graphical user interface, an adjusted chart representing the prediction data and the adjusted prediction data, wherein the adjusted chart emphasizes the adjusted prediction data over the prediction data.
